(19) United States
(12) Patent Application Publication
(10) Pub. No.: US 2021/0013582 A1
(43) Pub. Date: Jan. 14, 2021

(54) RADIO FREQUENCY MODULES WITH MILLIMETER-WAVE AIR-GAP PHASED-ARRAY ANTENNA

(71) Applicant: PERASO TECHNOLOGIES INC., Toronto (CA)

(72) Inventors: Atabak RASHIDIAN, North York (CA); Mihai TAZLAUANU, Markham (CA); Marc SUPINSKI, Toronto (CA)

(21) Appl. No.: 16/925,831

(22) Filed: Jul. 10, 2020

Related U.S. Application Data
(60) Provisional application No. 62/872,759, filed on Jul. 11, 2019.

(51) Int. Cl. H01Q 1/16; H01Q 23/00; H01Q 1/22

(52) U.S. Cl. CPC H01Q 1/16; H01Q 1/2283; H01Q 23/00

(57) ABSTRACT

A radio frequency module includes: a primary board including: an upper surface carrying a radio controller; and a lower surface carrying antenna control elements; a spacer affixed to the lower surface and having a predefined height extending away from the lower surface; and a secondary board affixed to the spacer, separated from the lower surface by an air gap having the predetermined height; the secondary board supporting a phased array of antenna elements.

### CROSS-REFERENCE TO RELATED APPLICATION

This application claims priority from U.S. provisional patent application No. 62/872,759, filed Jul. 11, 2019 and entitled “Air-Gap High-Gain Antenna”, the contents of which is incorporated herein by reference.

### FIELD

The specification relates generally to wireless communications, and specifically to a radio frequency module with millimeter-wave air-gap phased array antenna.

### BACKGROUND

The performance of wireless antenna elements is dependent, in part, on the precision of antenna geometry and on the characteristics and geometry of the antenna substrate—the material between the antenna elements and the ground layer, which is typically a dielectric material supporting the antenna elements. Certain substrate materials, as well as assembly configurations, have superior performance characteristics to others, but may also be costlier to fabricate, have larger physical footprints, and the like.

### SUMMARY

An aspect of the specification provides a radio frequency module, comprising: a primary board including: an upper surface carrying a radio controller; and a lower surface carrying antenna control elements; a spacer affixed to the lower surface and having a predefined height extending away from the lower surface; and a secondary board affixed to the spacer, separated from the lower surface by an air gap having the predetermined height; the secondary board supporting a phased array of antenna elements.

### BRIEF DESCRIPTIONS OF THE DRAWINGS

Embodiments are described with reference to the following figures, in which:

FIGS. 1A and 1B depict perspective views of a radio frequency module, from above and below;

FIG. 2 depicts a cross-section of the module of FIG. 1;

FIG. 3 depicts an exploded view of a portion of the module of FIG. 1, illustrating example spacer and stiffener structures;

FIG. 4 depicts an exploded view of a portion of the module of FIG. 1, illustrating further example spacer and stiffener structures;

FIG. 5A depicts an overhead view of a feed network of the module of FIG. 1;

FIG. 5B depicts a cross-sectional view of the feed network of FIG. 5A;

FIG. 6 depicts reflection coefficients for an example configuration of the module of FIG. 1, across WiGig frequencies;

FIG. 7 depicts gain relative to frequency for an example configuration of the module of FIG. 1; and

FIG. 8 depicts gain relative to steering angle in E and H planes for an example configuration of the module of FIG. 1.

### DETAILED DESCRIPTION

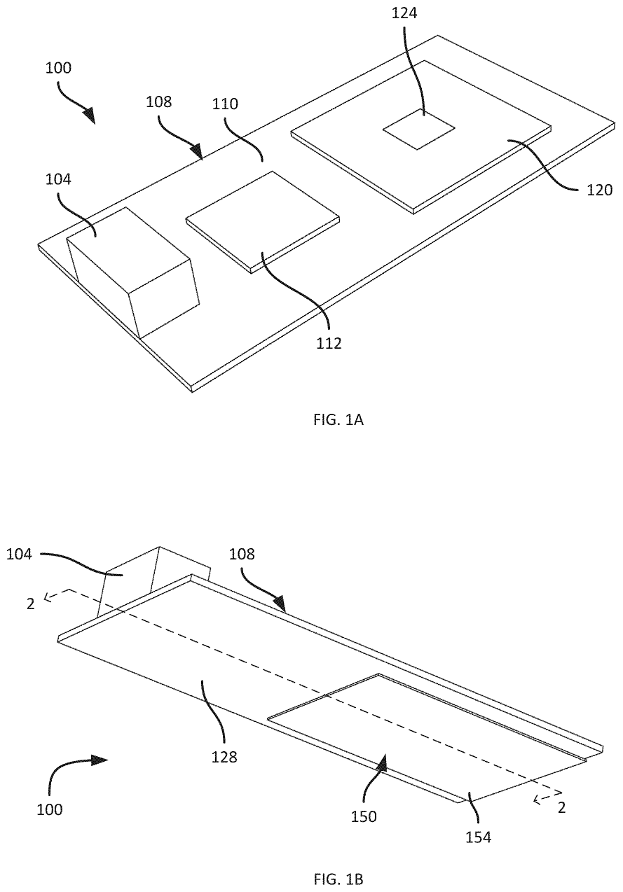

FIG. 1A depicts an example wireless communications assembly 100, also referred to as a radio frequency (RF) module 100 or simply the module 100, in accordance with the teachings of this disclosure. The module 100, in general, is configured to enable wireless data communications between computing devices (not shown). In the present example, the wireless data communications enabled by the module 100 are conducted according to the Institute of Electrical and Electronics Engineers (IEEE) 802.11ay standard, also referred to as WiGig, which employs frequencies of about 57 GHz to about 71 GHz (across six channels, each with a bandwidth of about 2 GHz). As will be apparent, however, the module 100 may also enable wireless communications according to other suitable standards, employing other frequency bands.

Antenna assemblies configured to communicate via standards such as WiGig may be subject to competing constraints. A first example of such constraints includes strict fabrication tolerances to provide desired performance attributes such as antenna bandwidth (e.g. to cover all six of the above-mentioned channels). A second example constraint is a reduction in production complexity and cost. As will be apparent to those skilled in the art, the above constraints may be in conflict, in that fabricating wireless communications assemblies to satisfy strict tolerances tends to increase cost and complexity of fabrication. As will be discussed below, the wireless communications module 100 includes various features to enable the provision of certain desirable performance attributes (such as full spectrum coverage of the WiGig frequency band) while mitigating the impact on fabrication cost and complexity that would typically be associated with such performance attributes.

The module 100 can be integrated with a computing device, or in other examples, can be implemented as a discrete device that is removably connected to a computing device. In examples in which the module 100 is configured to be removably connected to a computing device, the module 100 includes a communications interface 104, such as a Universal Serial Bus (USB) port, configured to connect the remaining components of the module 100 to a host computing device (not shown).

The module 100 includes a primary board 108, which may also be referred to as a primary support. In the present example, the primary board 108 is a printed circuit board (PCB), for example fabricated with FR4 material, carrying either directly or via additional boards, the remaining components of the module 100. In particular, the primary board 108 carries, e.g. on an upper surface 110 thereof, the above-mentioned communications interface 104. The upper surface 110 is referred to as “upper” to distinguish from the opposing surface, to be discussed below, and does not indicate a required orientation of the module 100 in use.

The primary board 108 also carries, on the upper surface 110, a baseband controller 112. The baseband controller 112 is implemented as a discrete integrated circuit (IC) in the present example, such as a field-programmable gate array (FPGA). In other examples, the baseband controller 112 may be implemented as two or more discrete components. In further examples, the baseband controller 112 can be integrated within the primary board 108 (i.e. be defined within the conductive layers of the primary board 108) rather than carried on the upper surface 110.

In the present example, the baseband controller 112 is connected to the primary board 108 via any suitable surface-mount package, such as a ball-grid array (BGA) package that electrically couples the baseband controller 112 to signal paths (also referred to as leads, traces and the like) formed within the primary board 108 and connected to other components of the module 100. For example, the primary board 108 defines signal paths (not shown) between the baseband controller 112 and the communications interface 104. Via such signal paths, the baseband controller 112 transmits data received at the module 100 to the communications interface for delivery to a host computing device, and also receives data from the host computing device for wireless transmission by the module 100 to another computing device. Further, the primary board 108 defines additional signals paths extending between the baseband controller 112 and further components of the module 100, to be discussed below.

The module 100 further includes an interposer 120 carrying a radio controller 124. The interposer 120 is a discrete component mounted on the upper surface 110 via a suitable surface-mount package (e.g. BGA). The interposer 120 itself carries the radio controller 124, and contains signal paths (also referred to as feed lines) for connecting control ports of the radio controller 124 to the baseband controller 112, and for connecting further control ports of the radio controller 124 to antenna elements to be discussed in greater detail below. The radio controller 124 may, for example, be placed onto or into the interposer 120 via a pin grid array or other suitable surface-mount package.

The module 100 may include a heatsink (not shown) placed over the baseband controller 112, the interposer 120 and the radio controller 124, and in contact with upper surfaces of those components, e.g. to exhaust heat generated by the components. In other examples, separate heat sinks may be placed over the baseband controller 112, and the combination of the interposer 120 and radio controller 124.

The radio controller 124 includes a transmit and a receive port for connection, via the interposer 120 and traces defined by the primary board 108, to the baseband controller 112. The radio controller 124 also includes a plurality of antenna ports for connection, via the interposer 120, to corresponding contacts on the upper surface 110 of the primary board 108. Those contacts, in turn, are connected to elements on the opposing lower surface of the primary board 108, to carry signals between the radio controller 124 and the above-mentioned antenna elements.

Turning to FIG. 1B, a lower surface 128 of the primary board 108 is shown opposite the upper surface 110. The above-mentioned antenna elements, such as a phased array of sixty-four antenna elements (although other arrangements of antenna elements are also contemplated), are supported on a secondary board 150, also referred to as a secondary support 150. The secondary board 150 includes an outer surface 154 (i.e. a surface facing away from the primary board 108) and an opposing inner surface (not visible in FIG. 1B) facing the primary board 108, and specifically, facing the lower surface 128 of the primary board 108. The antenna elements may be supported on the inner surface of the secondary board 150 in the present example. In other examples, however, the antenna elements may be supported on the outer surface 154 of the secondary board 150.

The module 100 includes additional components coupling the secondary board 150 to the primary board 108, which are not illustrated in FIG. 1B for simplicity, but are shown in subsequent figures and described below in greater detail.

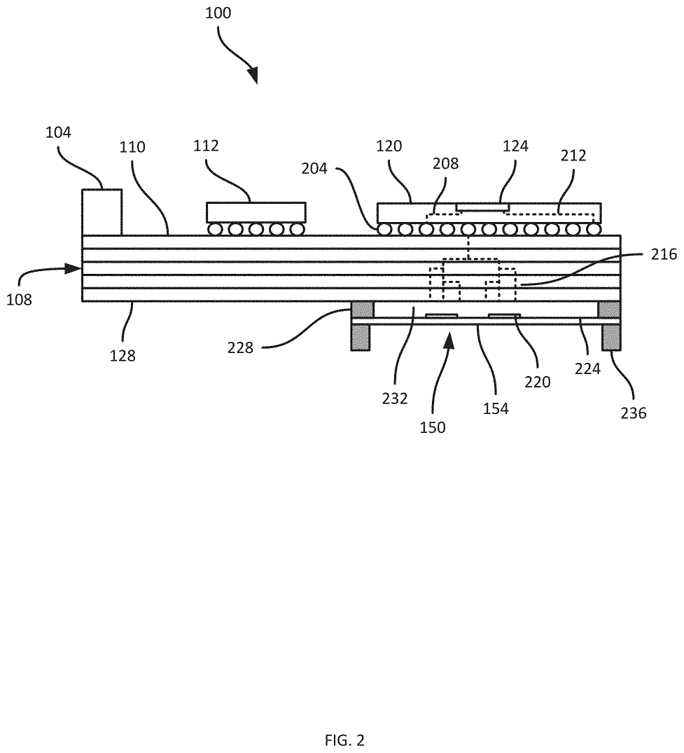

Turning to FIG. 2, the cross-section 2-2 indicated in FIG. 1B is illustrated. As seen in FIG. 2, the interposer 120 is connected to the upper surface 110 via a surface-mount package 204, which in the present example is a BGA package. The interposer 120 contains a plurality of internal feed lines, examples 208 and 212 of which are shown in FIG. 2, connecting control ports of the radio controller 124 to elements of the package 204 for electrical connection with control contacts on the upper surface 110. At least a portion of the control contacts on the upper surface 110 are connected to conduits extending through the primary board 108 from the upper surface 110 to the lower surface 128.

The conduits 216, also referred to as a feed network, convey signals from the radio controller 124 to a series of excitation patches or other antenna patch control elements on the lower surface 128, which are electromagnetically coupled to a series of antenna elements 220 disposed on the inner surface 224 of the secondary board 150 (e.g. the above-mentioned 64-element array). In other examples, the antenna elements 220 can be disposed on the outer surface 154 of the secondary board 150. The conduits 216 therefore also carry signals from the antenna elements 220, via the excitation patches, to the radio controller 124. As will be discussed in greater detail herein, the conduits 216 may connect to first subset of contacts at the upper surface 110 with a larger subset of contacts (i.e. having a greater number of contacts than the first subset) at the lower surface 128 (e.g. sixty-four, corresponding to the number of excitation patches deployed to power the sixty-four-element antenna array on the secondary board 150).

The secondary board 150 is affixed to the lower surface 128 of the primary board 108 by at least one spacer 228. The spacer 228 can be fabricated separately from the primary board 108 and the secondary board 150, e.g. from a material enabling strict dimensional tolerance (e.g. steel, aluminum, or the like). The spacer(s) 228 are affixed to the lower surface 128 and the secondary board 150 is affixed to the spacer(s) 228, an air gap 232 is formed between the inner surface 224 of the secondary board 150 and the lower surface 128. The air gap 232 provides sufficient impedance bandwidth for the antenna array carried by the secondary board 150. In addition, the dimensions (particularly the depth, as in the distance between the surfaces 128 and 224) of the air gap may be tightly controlled through fabrication of the spacer(s) 228.

The module 100 can also include a stiffener, or stiffening member, 236, affixed to the outer surface 154 of the secondary board 150. The stiffener 236 can be affixed to the secondary board via screws or other fasteners, which may also traverse the board 150, the spacer(s) 228 and terminate in the primary board 108. The stiffener 236 can mitigate warping of the secondary board 150, which may have a relatively small thickness and therefore be prone to warping in the absence of the stiffener 236. In other examples, the stiffener 236 may be omitted. The stiffener 236 can be fabricated from a metal (e.g. steel, aluminum), ceramic, or the like.

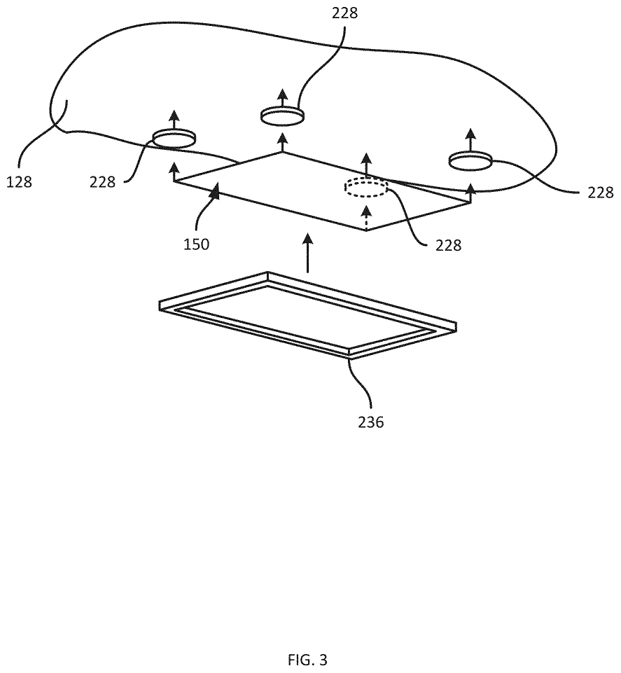

Various structures are contemplated for the spacer(s) 228. Turning to FIG. 3, a portion of the module 100 is illustrated in exploded form, illustrating part of the lower surface 128 of the primary board 108, as well as the secondary board 150, the spacer(s) 228, and the stiffener 236. In the illustrated example, the stiffener 236 is a frame configured to extend around the perimeter of the secondary board 150. The spacers 228 are implemented as a set of discrete spacers 228, e.g. affixed to the corners of the secondary board 150.

In other examples, additional spacers 228 can be provided at other points along the perimeter of the secondary board 150. In still other examples, spacers 228 may be provided between the lower surface 128 and an interior portion of the secondary board 150 (i.e. in addition to, or instead of, those placed along the perimeter of the secondary board 150). The stiffener 236, secondary board 150, spacers 228 and primary board 108 can be assembled by inserting screws or other fasteners (e.g. four, in the present example) through the stiffener 236, the secondary board 150, and the spacers 228 into openings in the lower surface 128.

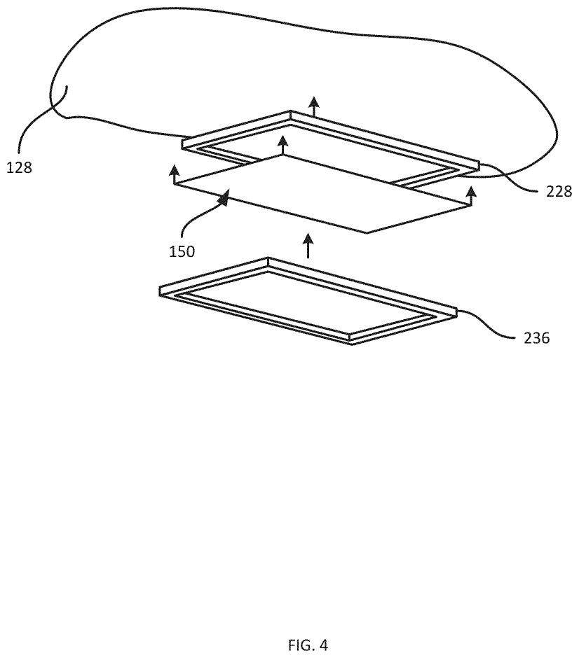

FIG. 4 illustrates a further implementation in which the spacer 228 and the stiffener 236 are both implemented as frames extending around the perimeter of the secondary board. Fasteners may be inserted through the stiffener 236, the secondary board 150, and the spacer 228 into the primary board 108, e.g. at the corners thereof. The spacer 228 and the stiffener 236 can include openings therethrough to receive fasteners such as screws. In other examples, the spacer 228 and the stiffener 228 can include openings between the corners thereof as well as, or instead of, at the corners.

The dimensions of the spacers 228, the stiffener 236, and the secondary board 150 can vary according to the desired transmission/reception characteristics of the module 100, the materials employed for the above components, and the like. In some examples, the spacer(s) 228 can have a thickness (as measured between the lower surface 128 and the inner surface 224, defining the depth of the air gap 232) of about 0.1 mm. The stiffener can have a thickness of about 0.4 mm, and the secondary board 150 can be a single-layer PCB having a thickness of about 0.3 mm. A wide variety of other dimensions may also be employed, however. Further, in other examples the secondary board 150 can be a multi-layer PCB to accommodate more complex antenna arrays, antenna arrays on both sides thereof, and the like.

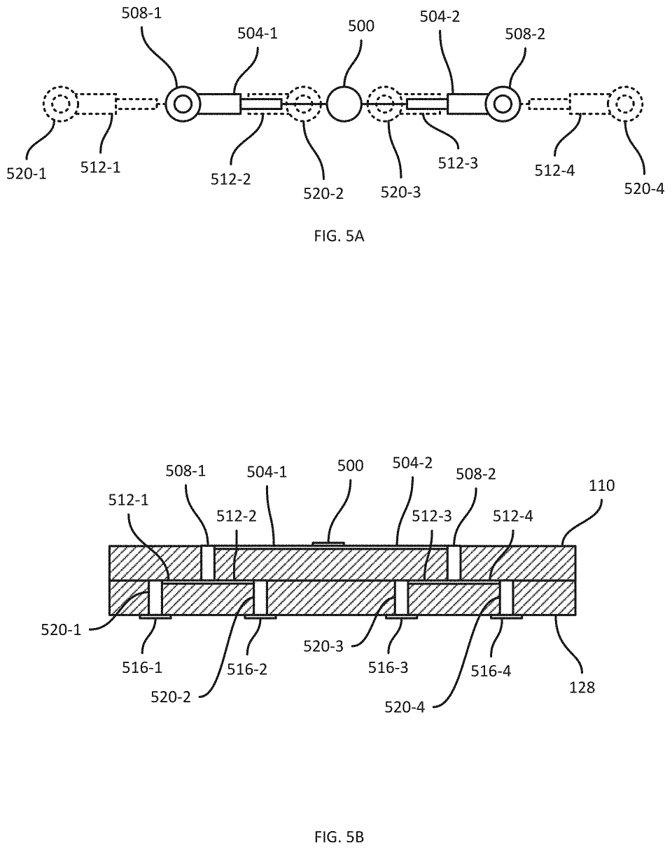

As noted earlier, the conduits 216 allow the exchange of signals between the antenna elements 220 (via the excitation patches on the lower surface 128) and the radio controller 124, by subdividing a first set of contacts on the upper surface 110 into a larger second set of contacts on the lower surface 128. Turning to FIGS. 5A and 5B, a simplified example set of conduits is shown in an overhead view (FIG. 5A) and a cross-sectional view (FIG. 5B).

The simplified feed networks in FIGS. 5A and 5B illustrate a first contact 500, e.g. on the upper surface 110, and connected to the radio controller 124 via the interposer 120. From the contact 500, feed lines (e.g. which may have wider traces as they depart from the contact 500) 504-1 and 504-2 travel to vias 508-1 and 508-2 (which may also be referred to as intermediate contacts). The vias 508 carry signals to a second conductive layer (e.g. separated from the conductive layer carrying the contact 500 by a dielectric core layer). On the second layer, additional feed lines 512-1, 512-2, 512-3, and 512-4 carry signals to excitations patches 516-1, 516-2, 516-3, and 516-4 through vias 520-1, 520-2, 520-3, and 520-4.

A wide variety of other structures for the conduits 216 can also be deployed. In general, as seen in FIGS. 5A and 5B, the stacked arrangement of conduits contemplated herein is more compact than an entirely planar feed network (e.g. contained entirely in one conductive layer), and may therefore reduce the complexity and cost of fabricating a primary board 108 with a set of excitation patches on the lower surface 108 with the spacing and placement to power the antenna elements 220.

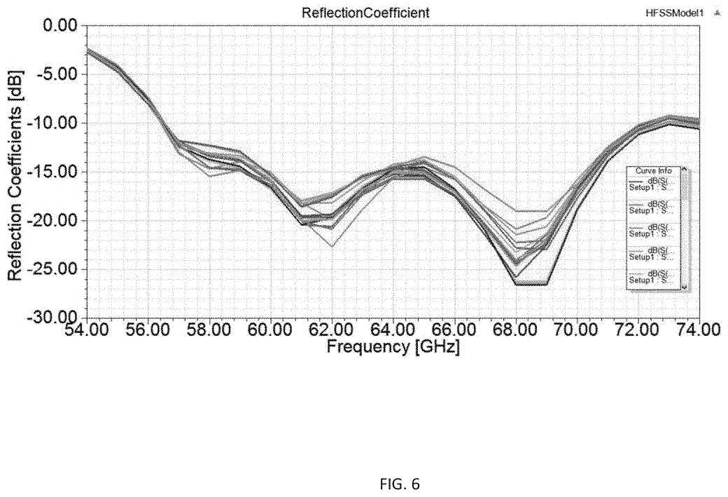

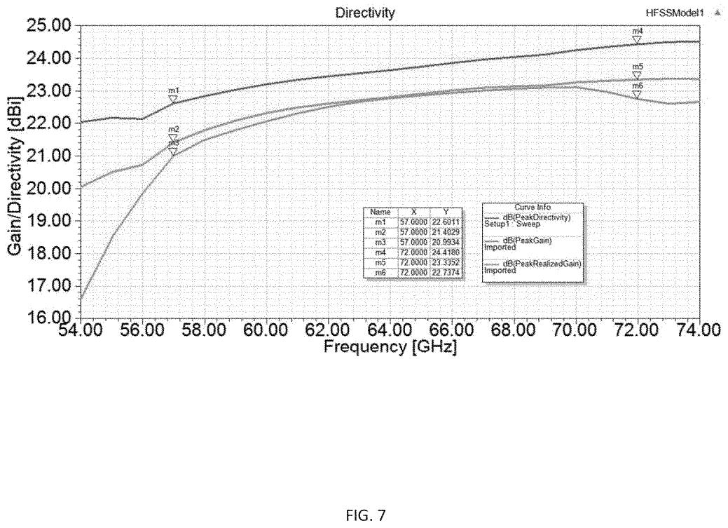

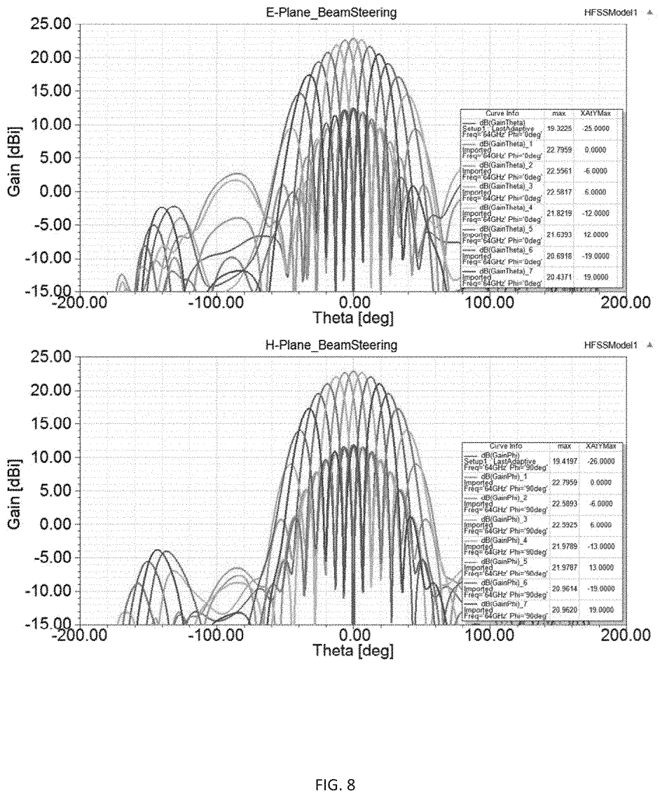

Certain configurations of the module 100 for use in WiGig communications achieve reflection coefficients below −10 dB for frequencies between 56.5 GHz and 72 GHz (i.e. across substantially the entire WiGig spectrum), as shown in FIG. 6, which illustrates reflection coefficients across sixteen ports. That is, all six WiGig channels may be employed by such an assembly. Further, the assembly configurations noted above may achieve gain up to 23 dBi, as shown in FIG. 7. Still further, such an assembly may be steered over angles of 30 degrees to either side of a center orientation with a decrease in signal strength of less than about 4 dB, as shown in FIG. 8.

The scope of the claims should not be limited by the embodiments set forth in the above examples, but should be given the broadest interpretation consistent with the description as a whole.

1. A radio frequency module, comprising:
a primary board including:
an upper surface carrying a radio controller; and
a lower surface carrying antenna control elements;
a spacer affixed to the lower surface and having a predefined height extending away from the lower surface; and
a secondary board affixed to the spacer, separated from the lower surface by an air gap having the predetermined height; the secondary board supporting a phased array of antenna elements.

2. The radio frequency module of claim 1, wherein the spacer comprises a frame extending around a perimeter of the secondary board.

3. The radio frequency module of claim 1, wherein the spacer comprises a plurality of discrete spacer elements.

4. The radio frequency module of claim 3, wherein the plurality of discrete spacer elements are disposed at a perimeter of the secondary board.

5. The radio frequency module of claim 1, further comprising a stiffening member affixed to an outer surface of the secondary board, the outer surface opposite an inner surface of the secondary board affixed to the spacer.

6. The radio frequency module of claim 5, wherein the stiffening member comprises a stiffening frame extending around a perimeter of the secondary board.

7. The radio frequency module of claim 1, further comprising a communications interface on the upper surface of the primary board.

8. The radio frequency module of claim 1, wherein the communications interface comprises a Universal Serial Bus (USB) interface.

9. The radio frequency module of claim 1, further comprising a baseband controller on the upper surface of the primary board.

10. The radio frequency module of claim 1, wherein the phased array of antenna elements is controllable to receive and transmit signals at frequencies between about 57 GHz and about 71 GHz.

11. The radio frequency module of claim 1, further comprising:
a plurality of excitation patches on the lower surface, electromagnetically coupled with the phased array;
a feed network connecting a subset of radio controller contacts with the excitation patches, the feed network including:
a first layer connecting the subset of radio controller contacts to a set of intermediate contacts greater in number than the subset of radio controller contacts; and
a second layer connecting the set of intermediate contacts to the excitation patches.
